(19) United States
(12) Patent Application Publication
(10) Pub. No.: US 2010/0043304 A1
(43) Pub. Date: Feb. 25, 2010

(54) DIAMOND TOOL AND METHOD OF MANUFACTURING THE SAME

(75) Inventors: Hyun Woo Lee, Incheon (KR); Jong Hwan Park, Seoul (KR); Sung Kun Lee, Seoul (KR); Shin Kyung Kim, Incheon (KR)

Correspondence Address: SEED INTELLECTUAL PROPERTY LAW GROUP PLLC, 701 FIFTH AVE, SUITE 5400, SEATTLE, WA, 98104, US

(73) Assignee: SHINHAN DIAMOND IND. CO., LTD., Incheon (KR)

(21) Appl. No.: 12/524,349

(22) PCT Filed: Apr. 23, 2007
(86) PCT No.: PCT/KR2007/001976

§ 371 Date: Sep. 24, 2009

(30) Foreign Application Priority Data
Jan. 26, 2007 (KR) 10-2007-0008303

(51) Int. Cl. B23P 5/00; B24D 3/04

(52) U.S. Cl. 51/309; 51/307

(57) ABSTRACT

Disclosed herein is a diamond tool and a method of manufacturing the same. The diamond tool includes a shank and a segment coupled to the shank having a compact having a plurality of grooves, and diamond particles inserted into the grooves and bonded to the compact. The grooves can be formed on the compact corresponding to a desired arrangement locations of the diamond particles. A metal powder injection molding method can be employed to prepare the compacts. More than one compact can be stacked to form the segment, so that the diamond particles can be arranged in various patterns in the segment, thereby achieving simplification of the process, which allows cost savings and process automation.

### BACKGROUND

1. Technical Field

The present invention relates to a diamond tool for cutting a workpiece and a method of manufacturing the same, and more particularly to a diamond tool that is manufactured using a compact having grooves formed therein corresponding to arrangement locations of diamond particles such that the diamond particles can be arranged in a desired pattern, and a method of manufacturing the diamond tool.

2. Description of the Related Art

Diamond tools are tools for grinding or cutting the surface of a workpiece. The diamond tool generally has a shank that is in the form of a wheel or disk and is coupled to a machining apparatus, and segments attached to an outer periphery of the shank to cut a workpiece.

Each of the segments includes a binder in the form of paste and diamond particles irregularly dispersed in the binder. In the manufacturing process of the segment, a mixture of the binder and the diamond particles is placed in a mold having a predetermined shape, sintered under heat and pressure and dried to provide the segment.

Although such a conventional manufacturing method has a merit in that the segments can be easily manufactured, it is disadvantageous in that it suffers from deviation in quality of products due to irregular distribution of the diamond particles.

Therefore, to solve such problems, one example of techniques for arranging diamond particles in a predetermined regular pattern is disclosed in U.S. Pat. No. 2,194,546. If the diamond particles are arranged in the predetermined regular pattern, it is possible to obtain regular arrangement of the diamond particles, which leads to enhancement in performance of products and to deviation reduction of the performance, improving reliability of the products.

As mentioned above, various methods for arranging the diamond particles in the predetermined regular pattern have been actively developed since the early 1990s, and examples thereof are disclosed in U.S. Pat. Nos. 4,925,457, 5,092,910, 5,049,165. In these methods, a wire mesh or a mesh screen having diamond particles arranged regularly thereon is placed on a flexible carrier formed of a thermoplastic binder and metallic fibers or a mixture thereof, and the diamond particles are then fitted into openings of the wire mesh or the mesh screen.

On the other hand, Korean Patent No. 366466 discloses a diamond tool and a method of manufacturing the same, which comprises preparing a metal matrix in a semi-dried state, placing a perforated plate (or wire mesh) having holes formed therein on the metal matrix, inserting diamond particles into the respective holes, and compressing the diamond particles to fit the diamond particles into the matrix or bonding the diamond particles to the matrix with an organic material so as to form a segment.

FIG. 1 is a flow diagram showing manufacture of a segment by a conventional method of manufacturing a diamond tool.

A conventional diamond tool comprises a shank and a segment 10 coupled to the shank to perform an actual cutting operation. To manufacture the segment 10, a sliced matrix 12 is prepared and a perforated plate (wire mesh) 14 having holes 15 formed therein is placed on the matrix 12. At this time, the holes 15 formed in the perforated plate 14 have a size necessary to allow diamond particles to pass therethrough and can be arranged at generally constant intervals. Therefore, the diamond particles 16 can be arranged at such intervals by fitting the diamond particles 16 into the holes 15.

Meanwhile, the matrix 12 is prepared in a semi-dried state, and thus, with the diamond particles 16 fitted into the holes 15, the upper sides of the diamond particles 16 are lightly pushed down by a compression platen 20 such that the diamond particles 16 can be fixed in place in the matrix 12 while being buried in the matrix.

Then, after lifting the compression platen 20 to remove the perforated plate 14, the diamond particles 16 are completely buried in the matrix 12 by sufficiently lowering the compression platen 20.

In the segment 10 produced by the procedure as described above, the diamond particles 16 can be arranged in multiple layers by repeating a series of such processes.

In such a conventional diamond tool and method of manufacturing the same, however, since the perforated plate (or wire mesh) 14 must be aligned with the matrix 12 to arrange the diamond particles 16 and the process of compressing the arranged diamond particles 16 on the matrix 12 is constituted of two steps, the process becomes complicated and the manufacturing time thereof increases. Furthermore, when arranging the diamond particles 16 using the wire mesh, although the diamond particles 16 can be arranged generally at constant intervals, they cannot be arranged in a desired pattern.

On the other hand, in the related art, there has been suggested a method of arranging the diamond particles on a powder compact or a metallic thin plate using an air suction jig. In this case, however, since the diamond particles cannot be secured to the surface of the powder compact or the metallic thin plate, the diamond particles are likely to move, making it difficult to obtain a desired arrangement of the diamond particles. Therefore, in the related art, a bonding material such as adhesives and the like is additionally applied to the surface of the powder compact or the metallic thin plate, and such an additional process results in a reduction of productivity. Furthermore, when sintering the compact to bind the diamond particles to the powder compact or the metallic thin plate, the adhesives applied to the surface of the powder compact or the metallic thin plate remain as impurities, causing deterioration of the diamond tool, and such adhesives and the like applied to secure the diamond particles make it difficult to achieve process automation.

### BRIEF SUMMARY

According to one embodiment, a diamond tool and a method of manufacturing the same includes a metal powder injection molding method to prepare compacts having grooves, into which diamond particles are inserted, and the compacts are stacked so as to form a segment, so that the diamond particles can be arranged in various patterns in the segment and the manufacturing process is simplified, thereby achieving cost savings and process automation.

According to one embodiment, a diamond tool includes a shank and a segment coupled to the shank, wherein the segment includes a compact formed by injection molding includes a plurality of grooves formed on a surface of the compact, and diamond particles are inserted into the grooves and bonded to the compact by pressure sintering, the plurality of grooves being formed on the surface of the compact corresponding to arrangement locations of the diamond particles.

The segment may include a plurality of compacts stacked in multiple layers, each of the compacts having the diamond particles inserted therein. Further, the segment may further include an upper molded layer stacked on the compact. Preferably, the grooves have a size of 110˜150% of the diamond particles. Further, the compact may include a material selected from the group consisting of a metal powder, a polymer compound, a ceramic material, and a mixture thereof.

According to one embodiment, a method of manufacturing a diamond tool includes preparing a compact having a plurality of grooves formed therein corresponding to arrangement locations of diamond particles, inserting the diamond particles into the grooves of the compact, and pressure sintering the diamond particles and the compact to bond the diamond particles to the compact.

According to one aspect, the step of preparing the compact may include preparing a mixture of a raw powder and a binder, and injection molding the mixture to form the compact having the plurality of grooves formed on the surface of the compact corresponding to the arrangement locations of the diamond particles. According to one aspect, the step of inserting the diamond particles may include supplying the diamond particles onto the surface of the compact, and removing remaining diamond particles that are not inserted into the grooves. According to one aspect, the step of removing the remaining diamond particles may include tilting the compact or applying vibration to the compact to remove the remaining diamond particles that are not inserted into the grooves. The method may include degreasing the binder from the compact before the step of pressure sintering the diamond particles and the compact. According to one aspect, the method may further comprise stacking an upper molded layer on the compact. According to one aspect, the method may include forming multiple layers by stacking additional compacts having other diamond particles inserted therein on the compact having the diamond particles inserted in the compact, before the step of pressure-sintering the compact and the diamond particles, the forming of the multiple layers comprising repeatedly preparing a plurality of the compacts, each having the plurality of grooves formed therein corresponding to the arrangement locations of the diamond particles, inserting the diamond particles into the grooves of each of the compacts, and stacking the compacts one after another from below. According to one aspect, the method may include stacking an upper molded layer on the uppermost compact. The raw powder may comprise a material selected from the group consisting of a metal powder, a polymer compound, a ceramic material, and a mixture thereof. Preferably, the grooves have a size of 110˜150% of the diamond particles. According to one aspect, each of the diamond particles may have a spherical coating layer on outer surface thereof.

### BRIEF DESCRIPTION OF THE SEVERAL VIEWS OF THE DRAWINGS

FIG. 1 is a flow diagram showing manufacture of a segment according to a prior art method of manufacturing a diamond tool;

FIG. 2 is a plan view of a diamond tool according to one embodiment;

FIG. 3 is a cross-sectional view of a segment of the diamond tool according to one embodiment;

FIG. 4 is a partial cross-sectional view illustrating an injection molding machine for producing a compact for a diamond tool according to one embodiment;

FIG. 5 is an isometric view illustrating the compact for a diamond tool according to one embodiment;

FIG. 6 is a flow diagram illustrating a segment at different steps of a method of manufacturing a diamond tool according to one embodiment;

FIG. 7 is a flow chart showing manufacturing of a segment by a method of manufacturing a diamond tool according to one embodiment;

FIG. 8 is a cross-sectional view illustrating a coated state of a diamond particle of a diamond tool according to one embodiment; and

FIG. 9 is a cross-sectional view illustrating a segment manufactured by a method of manufacturing a diamond tool according to another embodiment.

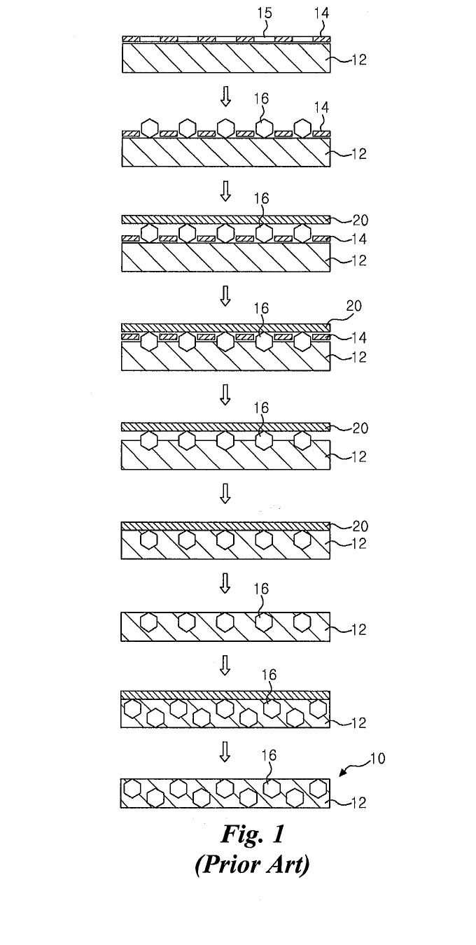

### DETAILED DESCRIPTION

Example embodiments are described in detail with reference to the accompanying drawings hereinafter.

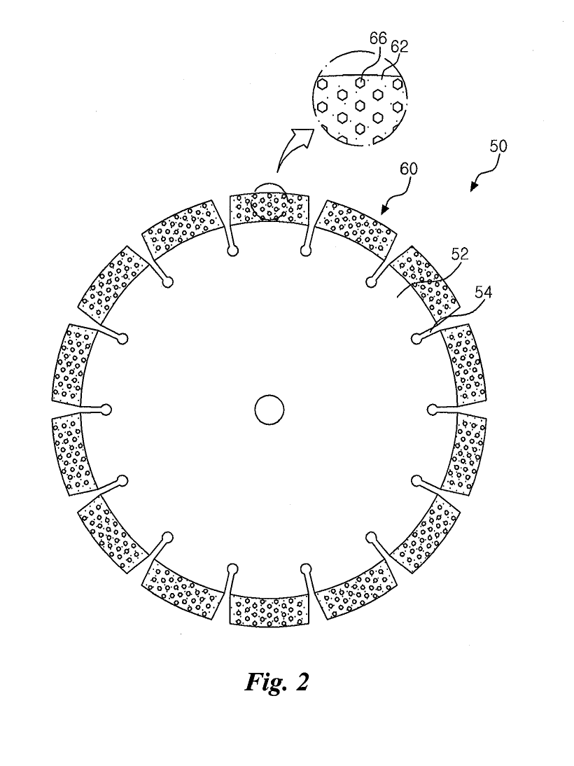

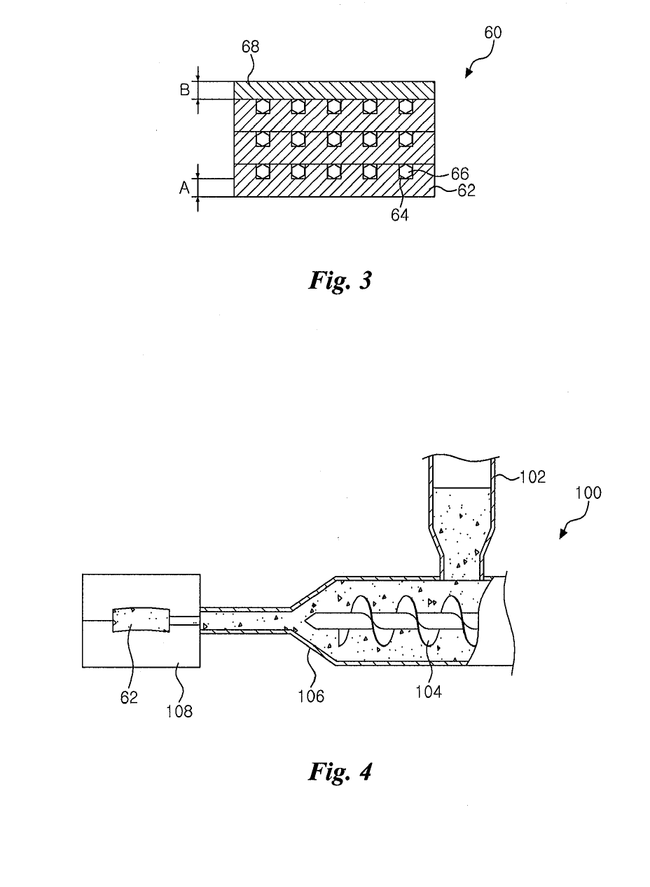

FIG. 2 is a plan view of a diamond tool 50 according to one embodiment, and FIG. 3 is a cross-sectional view of a segment 60 of the diamond tool 50 according to one embodiment.

Referring to FIGS. 2 and 3, the diamond tool 50 includes a shank 52 that has a wheel or disk shape and is to be coupled to a machining apparatus. The shank 52 has slots 54 of a predetermined length formed along an outer periphery toward a central axis of the shank 52. Further, the diamond tool 50 includes a plurality of segments 60, each of which has a plurality of diamond particles 66 arranged therein and is attached between the adjacent slots 54.

Each segment 60 includes compacts 62 formed by an injection molding process. Each of the compacts 62 has a plurality of grooves 64 formed on a surface thereof. The diamond particles 66 are located in the grooves 64 and bonded integrally to the compacts 62 by sintering.

According to one embodiment, the compacts 62 and the diamond particles 66 inserted into the compacts 62 can be stacked in multiple layers. The segment 60 further includes an upper molded layer 68 on the uppermost compact 62 and the diamond particles 66 thereof. A thickness B of the upper molded layer 68 is preferably the same as a thickness A between a lower surface of the compact 62 and respective bottom surfaces of the grooves 64.

In each of the segments 60, a separation between adjacent layers of the diamond particles 66 can be adjusted depending on a thickness of the compacts 62. For example, in the segment 60, the greater the thickness between the lower surface of the compact 62 and the bottom surfaces of the grooves 64, the greater a separation between the adjacent layers of the diamond particles 66. Thus, for the segment 60, it is possible to adjust the separation between the adjacent layers of the diamond particles 66 by adjusting the thickness between the lower surface of the compact 62 and the bottom surfaces of the grooves 64.

According to one embodiment, the thickness A between the lower surface of the compact 62 and the bottom surfaces of the grooves 64, that is, a thickness between the lowermost side and the uppermost side of the segment 60, can be different from the thickness B of the upper molded layer 68.

According to one embodiment, the grooves 64 have a size which enables each of the diamond particles 66 to be inserted into a single grooves 64, and in one aspect, have a size of 110˜150% of the diamond particles 66. When the grooves 64 are formed to the size of 110˜150% of the diamond particles 66, it is possible to allow easy insertion of the diamond particles 66 into the respective grooves 64 while preventing two or more diamond particles from entering a single groove 64.

According to one embodiment, the injection molding process employed to produce the compacts 62 is a powdered metal injection molding (MIM) process, which can be obtained by combining merits of both an injection molding process used in the plastic industry and a process of sintering metal powders, developed in the powder metallurgy industry.

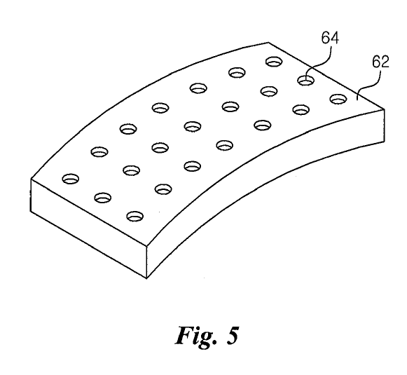

FIG. 4 is a view illustrating the configuration of an injection molding machine 60 for producing a compact 62 for a diamond tool according to one embodiment, and FIG. 5 is an isometric view illustrating the compact. Referring to FIGS. 4 and 5, the compact 62 is formed of a material such as a metal powder, a polymer compound, a ceramic material and/or a mixture thereof, and each of the materials is combined with a binder to maintain its shape upon injection molding. The binder can be composed of an organic compound, and according to one aspect, dried and removed from the compact 62 before the compact 62 and the diamond particles 66 are subjected to pressure sintering.

In the injection molding machine 100, the metal powder, any one of the polymer compound, the ceramic material and/or the mixture thereof is combined with the binder and supplied to a hopper 102, which in turn supplies a mixture of the material and the binder to a feeding device 104. The feeding device 104 is provided at one end thereof with a nozzle 106 to inject the mixture into a mold 108 to form the compact 62. The mold 108 is formed on an inner surface thereof with protrusions corresponding to an arrangement pattern of the diamond particles 66 so that the compact 62 formed by the mold has the grooves 64 corresponding to the arrangement pattern of the diamond particles 66.

A method of manufacturing a diamond tool according to one embodiment is described hereinafter.

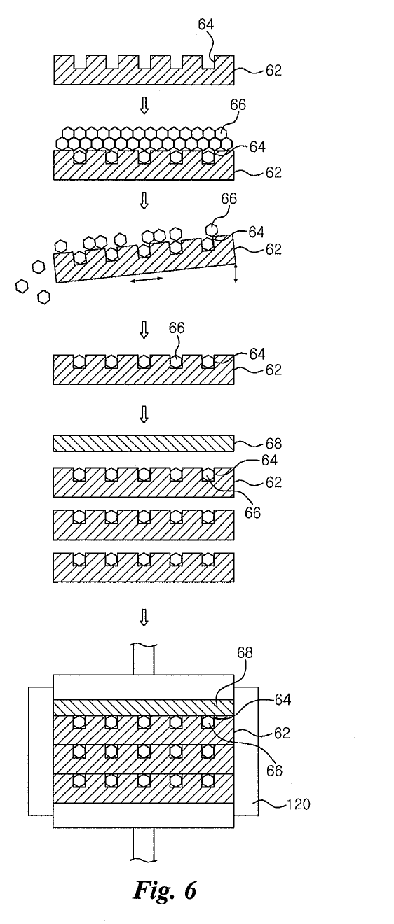

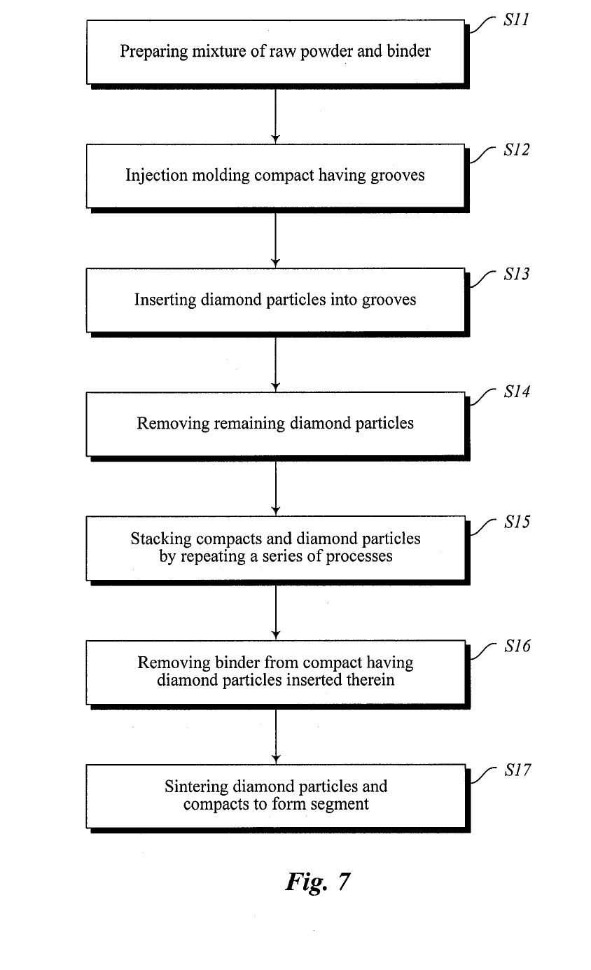

FIG. 6 is a flow diagram showing a method of manufacturing a segment of a diamond tool according to one embodiment, and FIG. 7 is a flow chart showing the segment in different steps of manufacturing the diamond tool according to one embodiment.

Referring to FIGS. 6 and 7, the method of manufacturing the diamond tool 50 includes preparing a compact 62 having a plurality of grooves 64 formed thereon corresponding to desired arrangement locations of diamond particles 66.

According to one aspect, preparing the compact 62 includes preparing a mixture of a raw powder and a binder (S11). The raw powder is a metal powder and is bonded to the diamond particles 66 by sintering. According to one aspect, the raw powder may be formed of a polymer compound or a ceramic material in place of the metal powder. According to one aspect, the raw powder may be formed of a material selected from the metal powder, the polymer compound, the ceramic material or a mixture thereof and may include other materials for improvement in performance.

Then, the mixture of the raw powder and the binder is formed into the compact 62 having a predetermined shape by the injection molding machine (S12). At this time, the compact 62 has a plurality of grooves 64 formed on the surface thereof corresponding to arrangement locations of the diamond particles 66. The compact 62 may be changed in shape depending on the shape of the mold of the injection molding machine. Thus, a variety of compacts can be produced by replacing proper molds according to arrangement patterns of the diamond particles 66.

According to one aspect, the compact 62 may be injection molded or supplied in an injection molded state before supplying the diamond particles 66.

According to one aspect, the grooves may have a size of approximately 110˜150% of the diamond particles 66. Therefore, it is possible to easily insert the diamond particles 66 into the respective grooves 64 while preventing two or more diamond particles 66 from being inserted into one groove 64.

After preparing the compact 62 as described above, the diamond particles 66 are inserted into the grooves 64 of the compact 62 (S13).

At the step of inserting the diamond particles 66 into the grooves 64, a number of diamond particles are set on the surface of the compact 62. According to one aspect, each of the diamond particles 66 is inserted into a single groove 64, and remaining diamond particles 66 are piled up on the compact 62. The remaining diamond particles 66 which are not inserted into the grooves 64 are removed (S14).

According to one aspect, removing the remaining diamond particles 66 includes tilting the compact 62 or applying vibration to the compact 62 such that the remaining diamond particles 66, which are not inserted into the grooves 64, can drop down from the compact 62.

According to one aspect, when inserting the diamond particles 66, the number of diamond particles 66 supplied is slightly more than the number of grooves 64 and vibration is applied to the compact 62 to allow the diamond particles 66 to be inserted into the respective grooves 64. When the amount of diamond particles 66 supplied is controlled as described above, it is possible to reduce time required for the process of removing the remaining diamond particles 66 and the process of recovering the removed diamond particles 66.

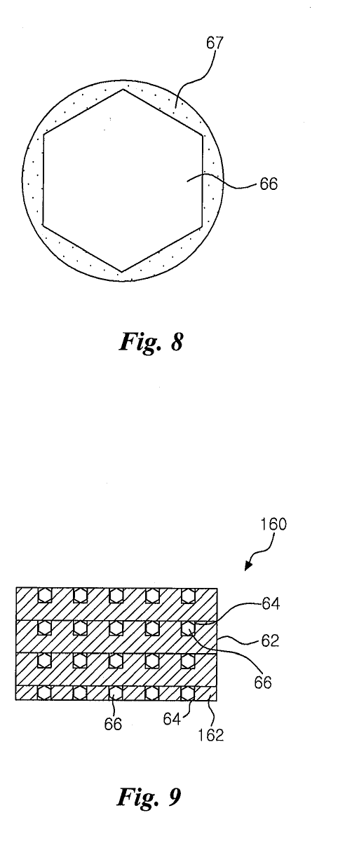

According to one embodiment, each of the diamond particles 66 may have a coating layer 67 on the surface thereof to facilitate supply and removal of the diamond particles, as shown in FIG. 8. FIG. 8 is a cross-sectional view illustrating a coated state of a diamond particle for the diamond tool according to one embodiment. The coating layer 67 can be formed in a spherical shape on the surface of each of the diamond particles 67, so that the diamond particles 67 can move easily.

Referring to FIGS. 6 and 7 again, in the segment 60, the diamond particles 66 may be arranged in a single layer or stacked in multiple layers. According to one embodiment, the method of manufacturing the diamond tool includes forming multiple layers wherein additional compacts 62 having corresponding diamond particles 66 inserted in the additional compact 62 are stacked on the compact 62 having the diamond particles 66 inserted in the compact 62.

According to one aspect, forming the multiple layers includes repeatedly preparing a plurality of the compacts 62, each of which has the plurality of grooves 64 formed at locations of the compact 64 corresponding to a desired arrangement of locations of the diamond particles 66, inserting the diamond particles 66 into the grooves 64 of each of the compacts 62, and stacking the compacts 62 one after another from below, such that the compacts 62 and the diamond particles 66 are stacked in multiple layers (S15).

According to one aspect, when forming the multiple layers, the compacts 62 are provided in a previously injection molded state, and the compacts 62 and the diamond particles 66 may have various arrangements depending on arrangement patterns of the grooves 64 formed in the respective compacts 62. As such, since a number of compacts 62 are indexed according to the respective arrangement patterns of the grooves, it is possible to realize inventory control, which enables mass production and reduces manufacturing costs.

Therefore, the step of forming the multiple layers enables the compacts 62 and the diamond particles 66 to be more rapidly stacked in the multiple layers, thereby further increasing production speed.

According to one aspect, an upper molded layer 68 may be stacked on the uppermost compact 62 and the diamond particles 66 thereof.

According to one aspect, the upper molded layer 68 may be formed to a thickness equivalent to a thickness between the lower surface of the compact 62 and the bottom surfaces of the grooves 64. As a result, the segment is formed to have a symmetrical structure in the vertical direction by the stacked compacts 62 and the upper molded layer 68.

According to one aspect, after the diamond particles 66 are inserted into the grooves 64 of each of the compacts 62, the binder is degreased from the compacts 62 (S16). For example, when the binder is formed of an organic compound and creates impurities during pressure sintering, the method benefits from degreasing the binder. According to one aspect, when degreasing, the compacts 62 are heated to a temperature sufficiently to vaporize the binder or more to remove the binder from the compacts 62.

After removing the binder, the compacts 62 having the diamond particles 66 inserted therein are subjected to pressure sintering (S17). The stacked compacts 62 and the diamond particles 66 are sintered to form the segment 60, which will be coupled to a shank 52 by a compression frame 120.

Then, one or more segments 60 formed by sintering are coupled to the outer periphery of the shank 52, forming the diamond tool.

Although the segment formed by a method of forming a diamond tool 50 has been described as including the multiple layers of the compacts 62 and the diamond particles 66 in the above embodiment, the present invention is not limited to this and the segment may include a single layer of the compact 62 and the diamond particles 66.

FIG. 9 is a cross-sectional view illustrating a segment manufactured by a method of manufacturing a diamond tool according to another embodiment.

Referring to FIG. 9, among compacts 62 of a segment according to this embodiment, the lowermost compact 162 has the same thickness as a depth of the grooves 64, which is opened at a lower portion. Accordingly, for the compact 162, diamond particles 66 received in the lowermost grooves 64 are exposed to the outside, and thus, when operating with a diamond tool 50, it becomes unnecessary to perform a process of exposing the diamond particles 66. As such, multiple layers of compacts 62 having blocked lower portions may be stacked on the lowermost compact 162 which has the perforated grooves 62. The diamond particles 66 of the uppermost compact 62 are in an exposed stated. By pressure sintering these compacts along with the diamond particles 66 in a compression frame 120, a segment 160 is formed.

As apparent from the above description, according to embodiments of the present invention, a diamond tool is manufactured using a compact formed by an injection molding method and having grooves which can be arranged in various patterns in the compact so as to provide various arrangement patterns of diamond particles, so that the diamond tool has improved cutting efficiency. As such, with the improved cutting efficiency of the diamond tool, it is possible to reduce loss of energy by vibration and heat during cutting operation, and to enhance operating efficiency, degree of accuracy and service life of the diamond tool. Furthermore, when forming the compact by injection molding, the grooves can be formed in a constant size such that a single diamond particle is inserted into each of the grooves. Furthermore, a method of manufacturing a diamond tool according to the present disclosure is amenable to process automation and results in cost savings while increasing the yield.

Although the present invention has been described with reference to the embodiments and the accompanying drawings, it is not limited to the embodiments and the drawings. It should be understood that various modifications and changes can be made to the present invention by those skilled in the art without departing from the spirit and scope of the present invention defined by the accompanying claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A diamond tool comprising:
a shank;
a segment coupled to the shank, the segment having at least one compact and a plurality of grooves formed on a surface of the compact; and
a plurality of diamond particles inserted into the grooves and bonded to the compact, the plurality of grooves being formed on the surface of the compact corresponding to a desired arrangement locations of the diamond particles.

2. The diamond tool according to claim 1 wherein the segment includes a plurality of compacts stacked in a plurality of layers, each of the compacts having a plurality of diamond particles inserted therein.

3. The diamond tool according to claim 1 wherein the segment includes an upper molded layer stacked on the compact.

4. The diamond tool according to claim 1 wherein the respective plurality of grooves have a size of 110˜150% of the diamond particles.

5. The diamond tool according to claim 1 wherein the compact includes a material selected from the group consisting of a metal powder, a polymer compound, a ceramic material, and a mixture thereof.

6. A method of manufacturing a diamond tool, comprising:
forming a plurality of grooves in a compact corresponding to a desired arrangement locations of a plurality of diamond particles;
inserting the diamond particles into the grooves of the compact; and
bonding the diamond particles to the compact.

7. The method according to claim 6 wherein forming the grooves in the compact includes:
preparing a mixture of a raw powder and a binder; and
injection molding the mixture to form the compact with the plurality of grooves formed on a surface of the compact corresponding to the desired arrangement locations of the diamond particles.

8. The method according to claim 6 wherein inserting the diamond particles includes:
supplying the diamond particles onto the surface of the compact; and
removing remaining diamond particles that are not inserted into the grooves.

9. The method according to claim 8 wherein removing the remaining diamond particles comprises:
tilting the compact or applying vibration to the compact to remove the remaining diamond particles that are not inserted into the grooves.

10. The method according to claim 6, wherein bonding the diamond particles includes:
degreasing the binder from the compact and pressure sintering the diamond particles and the compact.

11. The method according to claim 6, further comprising:
stacking an upper molded layer on the compact.

12. The method according to claim 6, further comprising:
stacking at least one additional compact having diamond particles inserted therein, on the compact having the diamond particles inserted in the compact.

13. The method according to claim 12, further comprising:
stacking an upper molded layer on the uppermost compact.

14. The method according to claim 6 wherein the raw powder includes a material selected from the group consisting of a metal powder, a polymer compound, a ceramic material, and a mixture thereof.

15. The method according to claim 6 wherein the grooves have a size of 110˜150% of the diamond particles.

16. The method according to claim 6 wherein each of the diamond particles has a spherical coating layer on an outer surface thereof.

17. The method according to claim 12 wherein stacking the at least one additional compact includes forming a plurality of grooves in each compact corresponding to desired arrangement locations of the diamond particles, inserting the diamond particles into the corresponding grooves of each of the compacts, and stacking the compacts.

18. The method according to claim 6 wherein the diamond particles are bonded to the compact by a pressure sintering process.

19. The diamond tool according to claim 1 wherein the compact is formed by an injection molding process.

20. The diamond tool according to claim 1 wherein the diamond particles are bonded to the compact by pressure sintering.
